(19) United States
(12) Patent Application Publication
(10) Pub. No.: US 2005/0229495 A1
(43) Pub. Date: Oct. 20, 2005

(54) Glass run for automobile

(76) Inventors: Kazuhiro Murase, Aichi-ken (JP); Masanori Aritake, Aichi-ken (JP); Hitoshi Omori, Aichi-ken (JP)

Correspondence Address: POSZ LAW GROUP, PLC, 12040 SOUTH LAKES DRIVE, SUITE 101, RESTON, VA, 20191, US

(21) Appl. No.: 11/085,236

(22) Filed: Mar. 22, 2005

(30) Foreign Application Priority Data
Mar. 23, 2004 (JP) P2004-085216

(51) Int. Cl. E06B 7/16

(52) U.S. Cl. 49/428; 49/415

(57) ABSTRACT

A glass run adapted to be mounted in an inner periphery of a door frame of a door in an automobile so as to guide a door window glass when the door window glass moves up and down and having a linear portion formed by extrusion and a corner portion molded by molding so as to be mounted in a corner part of the door frame, wherein a fixing lip is provided on the corner portion of the glass run, so that the fixing lip is fixed to the corner part of the door frame through a mounting member, the fixing lip being formed with a hard material and one end of the fixing lip being embedded and secured in the corner portion of the glass run during the molding.

### BACKGROUND OF THE INVENTION

1. Field of the Invention

The present invention relates to a glass run for an automobile which is mounted in an inner periphery of a door frame of an automobile door so as to guide a door window glass when the door window glass moves up and down.

2. Description of the Related Art

As shown in FIG. 5, a glass run 110, which guides a door window glass 5 when it moves up and down, is mounted in an inner periphery of a door frame 2 of an automobile door 1. Such a conventional mounting construction of the glass run 1 is shown in FIGS. 6 and 7. FIG. 6 is a perspective view of a corner part of the door frame 2, and FIG. 7 is a perspective view of a corner portion of the glass run 110 which corresponds to the corner part of the door frame 2.

Conventionally, the glass run 110 is, as shown in FIG. 5, mounted in a channel 3 in the door frame 2 not only to guide the door window glass 5 when it moves up and down but also to effect a seal between the door window glass 5 and the door frame 2. Furthermore, in the glass run 110, as shown in FIG. 4, an upper side portion, a front side portion and a rear side portion, which are made up of substantially straight linear portions 111, respectively, are connected together by corner portions 112 which are molded in such a manner that the linear portions so connected conform with the shape of the door frame 2 of the door 1.

Note that a seal between the door 1 and a vehicle body is effected by a door weather strip mounted on an outer periphery of the door frame 2 and/or an opening trim weather strip mounted on a flange of an opening in the vehicle body.

The glass run 110 includes, as shown in FIG. 7, an exterior side wall 120, an interior side wall 130 and a bottom wall 140 so as to form substantially a U-shaped cross section. An exterior seal lip 150 is provided in such a manner as to extend from the vicinity of a leading edge of the exterior side wall 120 toward the inside of the U-shaped cross section. In addition, an interior seal lip 160 is also provided in such a manner as to extend from the vicinity of a leading edge of the interior side wall 120 toward the inside of the U-shaped cross section.

The exterior side wall 120, the interior side wall 130 and the bottom wall 140 are inserted in the channel 3 provided in the door frame 2 in such a manner that external surfaces of the respective wall portions are brought into abutment with an internal surface of the channel 3 to thereby hold the glass run 110.

The door window glass 5 slides inside the U-shaped cross section of the glass run 110, and the exterior seal lip 150 and the interior seal lip 160 are in contact with the door window glass 5 to thereby effect a seal on both sides of an edge portion of the glass run 110, whereby the door window glass 5 is held in place (for example, refer to JP-2000-25462A (Pages 2 to 3, FIG. 2)).

However, an upper side of the door frame 2 has a longitudinal slope which inclines downwardly from rear to front, and hence the glass run 110 also has a similar slope which inclines to conform with the door frame 2. When the door window glass 5 ascends to come into abutment with the upper side of the glass run 110 at an upper edge thereof, the door window glass 5 exhibits a force which pulls the glass run 110 toward the rear along the slope, thereby causing a risk that the glass run may be dislocated from the glass run channel and is then crumpled toward the rear.

To cope with this, a recess 3b or a hole is provided in the vicinity of the corner portion of the glass run channel 3 provided in the door frame 2, so that a projection 113 provided on an external surface of the vicinity of the corner portion at the bottom wall 140 of the glass run 110 is inserted in the recess 3b or the hole, whereby the corner portion of the glass run 110 is fixed to the glass run channel so as to stop the deviation in position of the glass run 110 to thereby prevent the crumpling of the glass run 110 (for example, refer to JP-2000-158950A (FIG. 1) and JP-2000-103242A (FIG. 2)).

In a case where a pressed door is used, however, the glass run channel 3 in the door frame 2 is deleted from the viewpoint of reduction in weight and cost, and the glass run 110 is directly mounted on leading edges of an outer panel and an inner panel of the door frame 2. As this occurs, the projection 113 provided on the external surface of the bottom wall 140 of the glass run 110 cannot be fixed in the recess 3b in the glass run channel 3. Furthermore, since the bottom wall 140 of the glass run 110 is not fixed to the glass run channel 3, the glass run 110 tends to be crumpled more easily.

### SUMMARY OF THE INVENTION

The invention was made to cope with this problem and an object thereof is to provide a glass run for an automobile which can prevent the deviation in position of the glass run in the door frame so as to prevent the glass run from being crumpled toward the corner part of the door frame.

With a view to attaining the object, according to a first aspect of the invention, there is provided a glass run adapted to be mounted in an inner periphery of a door frame of an automobile door to guide a door window glass when said door window glass moves up and down, comprising:
a linear portion formed by extrusion;
a corner portion molded by molding so as to be mounted in a corner part of said door frame; and
a fixing lip provided on said corner portion;
wherein said fixing lip is fixed to said corner part of said door frame through a mounting member, and
said fixing lip is formed with a hard material and one end of said fixing lip is embedded and secured in said corner portion of said glass run during said molding.

According to the first aspect of the invention, since the fixing lip is provided on the external surface of the corner portion of the glass run and the fixing lip is fixed to the corner portion of the glass run through the mounting member, the corner portion of the glass run is fixed to the corner part of the door frame, even when the door window glass moves up and down, whereby the upper edge of the door window glass goes into and comes out of the glass run to thereby pull the glass run, the deviation of the whole glass run relative to the door frame can thus be prevented.

Since the fixing lip is formed with the hard material, the fixing lip can exhibit a strong resistance against the elongation and deviation of the glass run to thereby prevent the movement of the glass run. Due to the hard material, the elongation and deformation of the fixing lip itself is prevented, whereby the fixing lip can be fixed to the corner part of the door frame assuredly.

Since the fixing lip is embedded in the corner portion of the glass run at the end thereof during the molding, the fixing lip is strongly secured to the corner portion of the glass run. Furthermore, since the fixing lip is covered with the material of the corner portion of the glass run, the fixing lip is allowed to adhere to the corner portion of the glass run on both sides thereof, whereby the fixing lip is strongly secured to the corner portion of the glass run. Due to the insert molding being used, no special separate adhesion process is necessary, easing the fabrication of the glass run.

According to another aspect of the invention, there is provided a glass run, wherein said fixing lip is formed with a metal or a hard synthetic resin and a mount hole in which said mounting member is inserted is formed in another end of said fixing lip.

According to the above aspect of the invention, since the fixing lip is formed of a metal or a hard synthetic resin, the strength of the fixing lip is increased, thereby making it possible to ensure the prevention of the deviation in position of the glass run. In addition, since it is formed of a metal or a hard synthetic resin, the fixing lip can be formed into something like a plate, the fixing lip can easily be embedded in the corner portion of the glass run.

Since the mount hole in which the mounting member is inserted is provided in another end of the fixing lip which is opposite to the one end thereof where the fixing lip is embedded in the corner portion of the glass run during the molding (insert molding), one end of the mounting member is inserted in the mount hole in the fixing lip, whereas another end of the mounting member is inserted in a mount hole provided in a corresponding portion on the corner part of the door frame, whereby the corner portion of the glass run can easily be fixed to the corner part of the door frame.

### BRIEF DESCRIPTION OF THE DRAWINGS

FIG. 1 is a sectional view of a portion of a glass run according to an embodiment of the invention which is to be mounted in an upper portion of a door frame, resulting when taken along the line I-I in FIG. 5;

FIG. 2 is a partially enlarged front view of a corner portion of the glass run according to the embodiment of the invention;

FIG. 3 is a partially enlarged plan view of the corner portion of the glass run according to the embodiment of the invention;

FIG. 4 is a front view of the glass run according to the embodiment of the invention;

FIG. 5 is a side view of an automobile door;

FIG. 6 is a partially cut away perspective view of a corner part of a conventional door frame; and

FIG. 7 is a partially cut away perspective view of a corner portion of a conventional glass run.

### DETAILED DESCRIPTION OF THE PREFERRED EMBODIMENTS

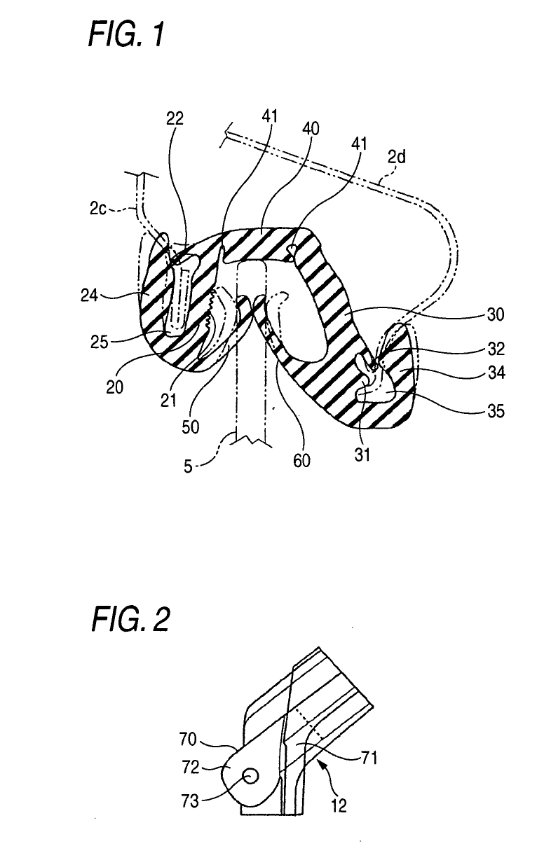

An embodiment of the invention will be described by reference FIGS. 1 to 5.

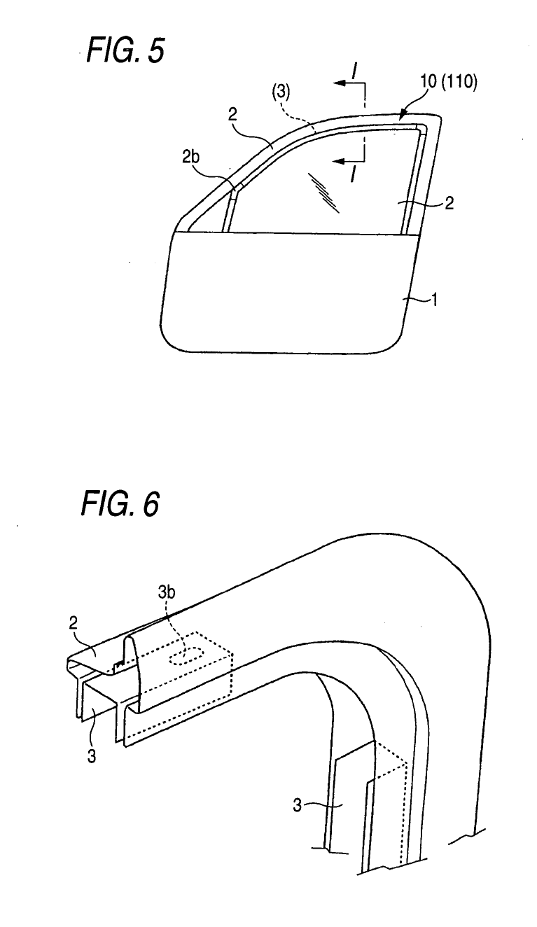

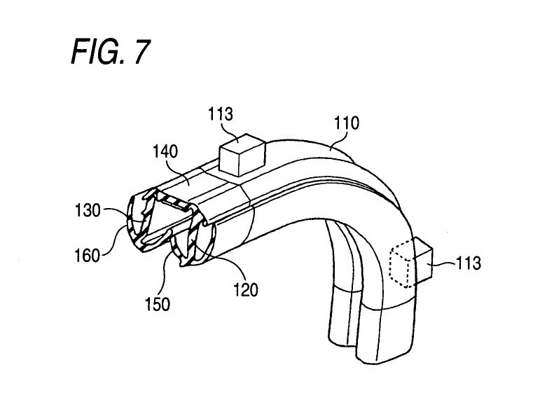

FIG. 5 is a side view of an automobile door 1 and FIG. 4 is a front view of a glass run 10 which is to be mounted in a door frame 2 of the door 1. As shown in FIG. 5, the door frame 2 is provided at an upper part of the automobile door 1 and a door window glass 5 is mounted in the door frame 2 in such a manner as to ascend and descend. Namely, the glass run 10 is mounted in an inner periphery of the door frame 2 so as not only to guide the door window glass 5 when it moves up and down but also to effect a seal between the door window glass 5 and the door frame 2.

The glass run 10 includes linear portions 11, which are substantially straight as a whole, formed by extrusion and corner portions 12 adapted to be mounted in corner parts of the door frame 2 and molded in such a manner as to connect the linear portions 11 to each other.

The linear portions 11 are made up, respectively, of a portion that is mounted in an upper side of the door frame 2, a portion that is mounted in a rear vertical side of the door frame 2 and a portion that is mounted in a front vertical side of the door frame 2.

The corner portions 12 are molded by molding in such a manner as to connect these extruded portions at the corner parts so as to conform with the shape of the door frame 2, and the corner portions 12 constitute portions that are to be mounted in the corner parts 2b of the door frame 2.

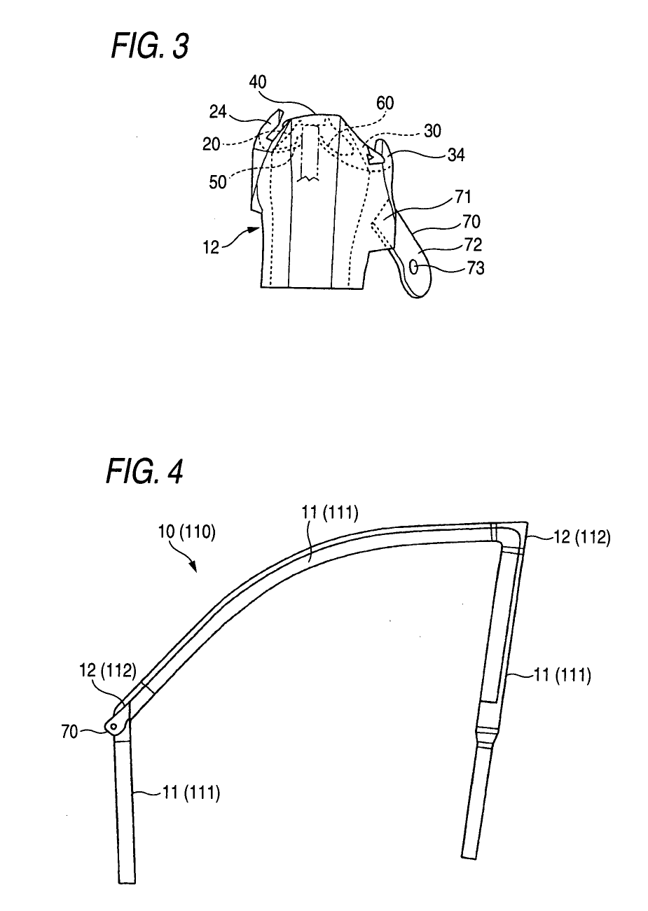

The cross sectional shape of the linear portion 11 that is mounted in the upper side of the door frame 2 is, as shown in FIG. 1, formed into a shape having substantially a U-shaped cross section, which is defined by an exterior side wall 20, an interior side wall 30 and a bottom wall 40. FIG. 1 is a sectional view taken along the line I-I in FIG. 5. FIG. 2 is an enlarged front view of the corner portion 12 of the glass run 10, and FIG. 3 is an enlarged plan view of the corner portion 12 of the glass run 10.

In the glass run 10, the portion mounted in the upper side portion of the door frame 2 and the portions mounted in the vertical side portions of the door frame 2 have almost similar substantially U-shaped cross sections.

An exterior seal lip 50 is provided in such a manner as to extend from the vicinity of a leading edge of the exterior side wall 20 toward the inside of the U-shaped cross section. In addition, an exterior cover lip 24 is provided in such a manner as to extend from the leading edge of the exterior side wall 20 toward the outside of the vehicle. An interior seal lip 60 is provided in such a manner as to extend from a leading edge of the interior side wall 30 toward the inside of the U-shaped cross section. In addition, an interior cover lip 34 is provided in such a manner as to extend from the leading edge of the interior side wall 30 toward the inside of the vehicle.

The exterior side wall 20 and the exterior cover lip 24 are made to continue to each other in substantially a U-shape, and an exterior groove portion 25 is provided therebetween. A leading edge of an outer panel 2c of the door frame 2 is inserted in this exterior groove portion 25, so that the outer panel 2c is held by the exterior side wall 20 and the exterior cover lip 24, whereby an exterior portion of the glass run 10 is thus held.

The exterior cover lip 24 covers an external surface of the outer panel 2c, and a leading edge thereof is brought into abutment with the outer panel 2c to thereby effect a seal between the glass run 10 and the outer panel 2c.

An exterior holding lip 22 is provided at the vicinity of a root of the exterior side wall 20 which is close to a portion where the exterior side wall 20 continues to the bottom wall 40 in such a manner as to close an entrance to the exterior groove portion 25. This exterior holding lip 22 is brought into abutment with the outer panel 2c so as to effect a seal between an internal surface of the outer panel 2c and itself. Furthermore, the exterior holding lip 22 is locked on a leading edge of a sheet metal which is bent into a hairpin bend at the leading edge of the outer panel 2c of the door frame 2, so that the dislocation of the glass run 10 from the outer panel 2c.

An elongated protruding portion 21 made up of longitudinally continuing fine irregularities is provided in an internal surface of the exterior side wall 20 which constitutes substantially a part of the U-shaped cross section. When the door is closed and the leading edge of the door window glass 5 is inserted into the interior of the glass run 10, while a leading edge of the exterior seal lip 50 is pressed to be brought into abutment with the elongated protruding portion 21 by the door window glass 5, as will be described later on, there is no case where a rear surface of the leading edge of the exterior seal lip 50 is made to adhere to the internal surface of the interior side wall 20, and hence there is no risk that abnormal noise is produced.

In addition, a low sliding resistance material such as a silicone resin may be applied or affixed to the internal surface of the exterior side wall 20 and the rear surface of the exterior seal lip 50. In this case, the adhesion of the exterior seal lip 50 and the exterior side wall 20 can further be prevented.

The leading edge of the exterior seal lip 50, which is provided in such a manner as to extend from the vicinity of the leading edge of the exterior side wall 20, is bent into a fallen V-like shape. A leading edge of the interior seal lip 60, which is provided in such a manner as to extend from the vicinity of the leading edge of the interior side wall 30, is similarly bent into a fallen V-like shape. When the door window glass 5 ascends and the upper edge thereof is inserted into the interior of the glass run 10, the exterior seal lip 50 and the interior seal lip 60 are brought into abutment, respectively, with an interior side and an exterior side of the upper edge of the door window glass 5 to thereby effect a seal between the door window glass 5 and the door frame 2.

The low sliding resistance material such as a silicone resin is applied to the surfaces of the exterior seal lip 50 and the interior seal lip 60 with which the door window glass 5 is brought into abutment. Due to this, when the door window glass 5 slides within the glass run 10, the sliding resistance of the door window glass 5 can be reduced, thereby making it possible to prevent the deviation in position of the glass run.

In addition, since the leading edges of the exterior seal lip 50 and the interior seal lip 60 are similarly bent into the fallen V-like shapes, the areas where the respective seal lips are brought into contact with the door window glass 5 are made small, whereby the sliding resistance against the door window glass 5 can be reduced by such an extent. In addition, a force by which the rear surfaces of the exterior seal lip 50 and the exterior seal lip 60 are made to adhere, respectively, to the internal surfaces of the exterior side wall 20 and the interior side wall 30 can be reduced.

As with the seal lips 50, 60, the low sliding resistance material such as a silicone resin or the like is applied to the bottom wall 40 on an internal surface of the U-shaped cross section, whereby the sliding resistance occurring against the door window glass 5 can be reduced.

Groove portions 41, 41 are provided along both edges of the internal surface of the bottom wall 40 so as to facilitate the deflection of the exterior side wall 20 and the interior side wall 30 of the glass run 10. Due to this, the bottom wall 40 maybe made slightly thicker, and even in case a glass channel for holding the bottom wall 40 of the glass run 10 is provided in the door frame 2, there is no case where the bottom wall 40 deforms abnormally even in the event that the door window glass 5 is brought into abutment with the bottom wall 40 to thereby press the same.

The interior side wall 30 and the interior seal lip 60 are formed larger and thicker and in such a manner as to extend more obliquely than the exterior side wall 20 and the exterior seal lip 50, respectively. Due to this, the door window glass 5 can be positioned toward the outside of the vehicle, thereby making it possible to decrease a difference in level between the door window glass 5 and the door frame 2, whereby air resistance or drag and wind noise can be reduced, and a preferable vehicle design can be promoted.

The interior side wall 30 and the interior cover lip 34 are formed in such a manner as to continue to each other in substantially a U-shape, and an interior groove portion 35 is provided therebetween. A leading edge of an inner panel 2d of the door frame 2 is inserted in this inter groove portion 35, so that a leading edge of the inner panel 2d is held by the interior side wall 30 and the interior cover lip 34, whereby the glass run 10 is thus held on an interior side thereof.

A protruding portion 31 and an interior holding lip 32 are provided in such a manner as to extend from the interior side wall 30 and toward the interior groove portion 35. When the leading edge of the inner panel 2d is inserted, since the leading edge of the inner panel 2d is slightly bent into a fallen V-like shape, the leading edge of the inner panel 2d is locked by the protruding portion 31, thereby making it possible to prevent the dislocation of the interior side of the glass run 10 from the door frame 2. In addition, the interior holding lip 32 is brought into abutment with the inner panel 2d to thereby hold the inner panel 2d, as well as effecting a seal between the inner panel 2d and the glass run 10.

Furthermore, a leading edge of the interior cover lip 34 is brought into abutment with the inner panel 2d to thereby improve the seal between the inner panel 2d and the glass run 10.

Next, referring to FIGS. 2 and 3, the corner portion 12 of the glass run 10 will be described.

FIG. 2 is the enlarged front view of the front corner portion 12 of the glass run 10, which illustrates a state in which a fixing lip 70 is mounted on the corner portion 12 of the glass run 10. FIG. 3 is the enlarged plan view of the same front corner portion 12 of the glass run 10.

The corner portion 12 is molded so as to connect the linear portion 11 constituting the upper side portion and the linear portion 11 constituting the vertical side portion. The cross sectional shape of the corner portion 12 is substantially the same as the cross sectional shapes of the linear portions. Namely, while the corner portion 12 is formed into a shape having substantially a U-shaped cross section by an exterior side wall 20, an interior side wall 30 and a bottom wall 40, the corner portion 12 functions to continuously change the cross section of the upper side portion to the cross section of the vertical side portion or vice versa so as to join the upper side portion and the vertical side portion.

Furthermore, an exterior seal lip 50 is provided in such a manner as to extend from the vicinity of a leading edge of the exterior side wall 20 toward the inside of the U-shaped cross section while matching the cross sectional shapes of the upper side portion and the vertical side portion. In addition, an exterior cover lip 24 is provided along the leading edge of the exterior side wall extending toward the outside of the vehicle. An interior seal lip 50 is provided in such a manner as to extend from a leading edge of the interior side wall 30 toward the inside of the U-shaped cross section, and an interior cover lip 34 is provided along the leading edge of the interior side wall 30 extending toward the inside of the vehicle. These seal lips and cover lips also similarly function to continuously change the difference in cross sectional shape between the upper side portion and the vertical side portion at the corner part so as to join the upper side portion and the vertical side portion together thereat.

The fixing lip 70 is embedded in the interior cover lip 34 of the corner portion 12 which continues to the upper side portion of the glass run 10. The fixing lip 70 is mounted on the upper side portion along the direction in which the exterior cover lip 34 extends. The fixing lip 70 is made into a rectangular plate-like shape, and one end thereof constitutes an embedment portion 71 where the fixing lip 70 is to be embedded in the exterior cover lip 34, whereas another end of the fixing lip 70 constitutes a fixing portion 72 where the fixing lip 70 is to be mounted and fixed to the door frame. A mount portion 73, which is a hole in which a clip or the like is inserted, is formed in the fixing portion 72. This mount portion 73 may be formed into, instead of the hole, an integral portion with the clip, which constitutes the mounting member or a cylindrical projection, as will be described later on.

A hard synthetic resin or a sheet metal can be used for this fixing lip 70. In the event that the fixing lip 70 is formed with such a hard synthetic resin, olefin hard synthetic resins such as polyethylene and polypropylene or nylon can be used. In the event that the corner portion 12 of the glass run 10 is formed with an olefin thermoplastic elastomer, the fixing clip 70 is preferably formed with an olefin synthetic resin. In this case, good adhesion can be provided by olefin thermoplastic elastomer and olefin synthetic resin, whereby the fixing lip 70 can be secured integrally by molding (insert molding).

In the event that the corner portion 12 of the glass run 10 is formed with EPDM rubber, a fixing lip 70 of a sheet metal or from nylon resin can be used. This is preferable since there is no risk that the fixing lip 70 is subjected to thermal change during vulcanization of the corner portion 12.

In the event that the fixing lip 70 is formed of a sheet metal, it is preferable that a plurality of small holes are opened in the embedment portion 71 for joint to the corner portion 12. Namely, a material forming the corner portion 12 enters the plurality of small holes in the embedment portion 71 at the time of molding, whereby the material existing on both sides of the embedment portion 71 is made to continue to each other from both the sides through the plurality of small holes to thereby become integral with each other, the sheet metal and hence the fixing lip 70 being thereby securely held in the material.

When the glass run 10 is mounted in the door frame 2, as has been described above, the leading edges of the outer panel 2c and the inner panel 2d of the door frame 2 are fitted, respectively, in the exterior groove portion 25 and the interior groove portion 35 of the glass run 10.

In the corner portion 12, in a similar way, the corner portion 12 of the glass run 10 is fitted in the corner part 2b of the door frame 2. As this occurs, a mount hole is provided in the inner panel 2d of the door frame 2 at a corresponding location on the corner part 2b, and the mount hole so provided is aligned with the hole provided as the mount portion 73 in the fixing lip 70 on the corner portion 12 of the glass run 10, so that the clip or the cylindrical mounting member is inserted into both the holes so as to fix the fixing lip 70.

By adopting this construction, the movement of the glass run 10 can be prevented. Note that in the event that the clip or the cylindrical projection is provided integrally on the fixing lip 70, the clip or the cylindrical projection may be inserted into the mount hole in the inner panel 2d. Due to this, by molding the fixing lip 70 in such a state that the fixing lip 70 is embedded in the corner portion 12 of the glass run 10, the mounting member that is to be mounted on the corner part 2b of the door frame 2 can be formed integrally on the fixing lip 70. Thus, when mounting the glass run 10, the clip or the projection only has to be inserted simply in the mount hole in the corner part 2b of the door frame 2, this facilitating the mounting of the glass run 10 in the door frame 2.

In addition, since the mounting member can be formed integrally with the fixing lip 70 at the same time that the fixing lip 70 is molded, the fabrication of the glass run can be facilitated.

Thus, even in the event that the glass run 10 is pulled by the door window glass 5 which enters the interior thereof, the fixing lip 70 prevents the deviation in position of the glass run 10 by the door window glass 5, thereby making it possible to fix the glass run 10 in place.

In forming the glass run 10, synthetic rubber, thermoplastic elastomer and soft synthetic resin are used as a molding material, and for example, an EPDM rubber as the synthetic rubber, a polyolefin elastomer as the thermoplastic elastomer and a soft polyvinyl chloride as the soft synthetic resin are used.

In the event that such a synthetic rubber is used, after extrusion, an extruded product is conveyed to a vulcanization tank for vulcanization while being heated by hot air or high-frequency waves. In the case of thermoplastic elastomer or soft synthetic resin, the extruded product is cooled and solidified. Thereafter, the resulting product is then cut to a predetermined length, whereby an extruded portion is manufactured.

Next, in molding a molded portion, the extruded member manufactured as described above is cut to the predetermined length, and end portions of the resulting extruded portions are then held in a mold unit for molding a molded portion, a solid material for molding a molded portion being injected into a cavity in the mold unit. The cross sectional shape of a molded portion to be molded is substantially the same as that of the extruded portion. It is preferable to use the same material as that used for the extruded portion as a molding material. In the case of thermoplastic elastomer or soft synthetic resin, since the material injected is in a molten state when it is injected into the mold unit, the extruded portions are fusion welded to the molded portion to be molded due to the heat and pressure of the material so injected.

In the case of synthetic rubber, a synthetic rubber material is injected into the mold unit, whereafter the mold unit is heated for vulcanization. As this occurs, since the extruded portions and the molded portion can be made to vulcanization adhere to each other, the respective portions are secured to each other as an integral part. Note that in the event that the extruded portions are formed with synthetic rubber, the molded portion can also be molded from thermoplastic elastomer.

In the invention, there may be provided a glass run, wherein the glass run includes an exterior side wall, an interior side wall and a bottom wall so as to form substantially a U-shaped cross section and an exterior seal lip and an interior seal lip are provided in said exterior side wall and said interior side wall respectively, extending toward an inside of the U-shaped cross section, so that said exterior seal lip and said interior seal lip seal an exterior surface and an interior surface of an edge portion of said door window glass respectively.

According to the above configuration, the glass run includes the exterior side wall, the interior side wall and the bottom wall so as to form substantially the U-shaped cross section, and the exterior seal lip and the interior seal lip are provided on the exterior side wall and the interior side wall, respectively, extending toward the inside of the U-shaped cross section. Due to this, when the door window glass is closed, the edge portion of the glass run can be accommodated substantially in the internal side of the U-shaped cross section of the glass run defined by the exterior side wall, the interior side wall and the bottom wall, whereby the door window glass can be held therein assuredly.

Since the exterior seal lip and the interior seal lip are joined, respectively, to the exterior side and the interior side of the edge portion of the door glass window to thereby effect a seal, the seal lips are brought into abutment with the door window glass as the door window glass moves up and down, and the seal between the door frame and the door window glass can be effected by the exterior seal lip and the interior seal lip.

In the invention, there may be provided a glass run, wherein a clip or an projection serving as said mounting member is integrally formed in another end of said fixing lip.

According to the above configuration, since the clip or the projection serving as the mounting member is formed integrally on another end of the fixing lip, by forming the one end of the fixing lip in such a manner as to be embedded in the corner portion of the glass run, the mounting member that is mounted on the corner part of the door frame can be mounted together the fixing lip only by simply inserting the clip or the projection in the mounting hole in the corner part of the door frame, this easing the mount of the glass run in the door frame.

In addition, since the mounting member can be formed integrally at the same time that the fixing lip is formed, the fabrication of the glass run can be facilitated.

In the invention, there may be provided a glass run, wherein the corner of the glass run is formed with an olefin thermoplastic elastomer and the fixing lip is formed with an olefin synthetic resin.

According to the above configuration, since the corner of the glass run is formed with an olefin thermoplastic elastomer and the fixing lip is formed with an olefin synthetic resin, good adhesion properties can be provided between the olefin thermoplastic elastomer and the olefin synthetic resin, whereby when the fixing lip is formed in such a manner as to be embedded in the corner portion of the glass run during the molding, the fixing lip can be secured to the corner portion of the glass run integrally and strongly.

In addition, since the glass run is formed with an olefin thermoplastic resin or EPDM rubber and the fixing lip is formed with an olefin synthetic resin, a product can be obtained which is superior in resistance to weathering and which can easily be recycled.

In the invention, there may be provided a glass run, wherein the fixing lip is provided on the front and rear corner portions of the glass run.

According to the above configuration, since the fixing lip is provided on both the front and rear corner portions of the glass run, the glass can be fixed at both longitudinal ends of the upper side thereof, thereby making it possible to prevent the deviation in position of the glass run in a more secured fashion.

In the invention, there may be provided a glass run according to any of the first to sixth aspects, wherein a low sliding resistance material is applied to internal surfaces of the exterior sidewall, the inside side wall and the bottom wall, and external surfaces of the exterior seal lip and the interior seal lip.

According to the above configuration, since the low sliding resistance material is applied to internal surfaces of the exterior side wall, the inside side wall and the bottom wall, and external surfaces of the exterior seal lip and the interior seal lip, when the door window glass slides within the glass run, the sliding resistance thereof can be reduced, whereby the low sliding resistance material together with the fixing lip can serve to prevent the deviation in position of the glass run. In addition, abnormal noise, which would be produced by virtue of friction between the door window glass and the glass run, can be prevented.

Even in the event that the seal lips are pressed against the side walls due to transverse movements of the door window glass when the upper edge thereof is inserted into the glass run, since the exterior side wall and the exterior seal lip, and the interior side wall and the interior seal lip are not affixed to each other, no abnormal noise is produced and the sealing properties can be maintained.

According to the invention, since the fixing lip or lips is or are provided on the external surface or surfaces of the corner portion or portions of the glass run for fixing the glass run to the corner part or parts of the door frame, the corner portion or portions of the glass run is or are fixed to the corner part or parts of the door frame, whereby the deviation in position of the whole glass run relative to the door frame can be prevented.

1. A glass run adapted to be mounted in an inner periphery of a door frame of an automobile door to guide a door window glass when said door window glass moves up and down, comprising:
a linear portion formed by extrusion;
a corner portion molded by molding so as to be mounted in a corner part of said door frame; and
a fixing lip provided on said corner portion;
wherein said fixing lip is fixed to said corner part of said door frame through a mounting member, and
said fixing lip is formed with a hard material and one end of said fixing lip is embedded-and secured in said corner portion of said glass run during said molding.

2. A glass run according to claim 1, wherein said glass run includes an exterior side wall, an interior side wall and a bottom wall so as to form substantially a U-shaped cross section, and an exterior seal lip and an interior seal lip are provided in said exterior side wall and said interior side wall respectively, extending toward an inside of the U-shaped cross section, so that said exterior seal lip and said interior seal lip seal an exterior surface and an interior surface of an edge portion of said door window glass respectively.

3. A glass run according to claim 1, wherein said fixing lip is formed with a metal or a hard synthetic resin and a mount hole in which said mounting member is inserted is formed in another end of said fixing lip end.

4. A glass run according to claim 1, wherein a clip or an projection serving as said mounting member is integrally formed in another end of said fixing lip.

5. A glass run according to claim 1, wherein said corner portion of said glass run is formed with an olefin thermoplastic elastomer and said fixing lip is formed with an olefin synthetic resin.

6. A glass run according to claim 1, wherein said fixing lip is provided on front and rear corner portions of said glass run.

7. A glass run according to claim 1, wherein a low sliding resistance material is applied to internal surfaces of said exterior side wall, said inside side wall and said bottom wall, and external surfaces of said exterior seal lip and said interior seal lip.
